(19) United States
(12) Patent Application Publication
(10) Pub. No.: US 2024/0015017 A1
(43) Pub. Date: Jan. 11, 2024

(54) INFORMATION PROCESSING APPARATUS, MANAGEMENT SERVER, SERVICE SYSTEM, AND NON-TRANSITORY COMPUTER READABLE MEDIUM

(71) Applicant: FUJIFILM Business Innovation Corp., Tokyo (JP)

(72) Inventor: Takashi MOMMA, Kanagawa (JP)

(73) Assignee: FUJIFILM Business Innovation Corp., Tokyo (JP)

(21) Appl. No.: 18/180,303

(22) Filed: Mar. 8, 2023

(30) Foreign Application Priority Data
Jul. 8, 2022 (JP) 2022-110172

(51) Int. Cl. H04L 9/32; H04L 9/40; H04L 9/30; H04L 9/14

(52) U.S. Cl. CPC H04L 9/321; H04L 63/0884; H04L 9/30; H04L 9/14

(57) ABSTRACT

An information processing apparatus that is registered in a service by registering, in a management server, registration information unique to the information processing apparatus, the information processing apparatus includes a processor configured to, in response to a registration representation instruction from a second information processing apparatus having no access to the service, transmit, to the management server, a proxy registration instruction including certification information certifying that registration information unique to the second information processing apparatus and registration information unique to the information processing apparatus have been registered in the management server, the registration information unique to the second information processing apparatus being included in the registration representation instruction to be registered in the management server.

### CROSS-REFERENCE TO RELATED APPLICATIONS

This application is based on and claims priority under 35 USC 119 from Japanese Patent Application No. 2022-110172 filed Jul. 8, 2022.

### BACKGROUND

### (i) Technical Field

The present disclosure relates to an information processing apparatus, a management server, a service system, and a non-transitory computer readable medium.

### (ii) Related Art

Services are available to perform centralized management on Internet of Things (IoT) devices. Registration of information about a number of IoT devices in a service is time consuming. In the related art, an IoT device that is registered works as a parent IoT device of an unregistered IoT device and acts for authentication on behalf of the unregistered IoT device. Time to register the unregistered IoT device on a management service may thus be reduced (as disclosed in Japanese Unexamined Patent Application Publication No. 2021-184170).

If credibility of a registered information processing apparatus is referenced to register an unregistered information processing apparatus in a service, time for authentication by the service may be reduced.

Japanese Unexamined Patent Application Publication No. 2017-126191 also discloses related technique.

In the related art, an information processing apparatus registered in the service searches for another information processing apparatus that is to be represented by the registered information processing apparatus as a proxy. In an environment where a large number of apparatuses to be represented by the registered apparatus are present, apparatuses to be represented and apparatuses not to be represented may coexist. In such an environment, the information processing apparatus registered in the service acting as an operation starting point searches for another information processing apparatus to be represented but this may place a burden on the registered information processing apparatus.

### SUMMARY

Aspects of non-limiting embodiments of the present disclosure relate to facilitating a registration operation of an unregistered information processing apparatus in a service performed at an operation starting point of registration in the service, in comparison with when a registered information processing apparatus is not used on the service.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus that is registered in a service by registering, in a management server, registration information unique to the information processing apparatus, the information processing apparatus comprising a processor configured to, in response to a registration representation instruction from a second information processing apparatus having no access to the service, transmit, to the management server, a proxy registration instruction including certification information certifying that registration information unique to the second information processing apparatus and registration information unique to the information processing apparatus have been registered in the management server, the registration information unique to the second information processing apparatus being included in the registration representation instruction to be registered in the management server.

### BRIEF DESCRIPTION OF THE DRAWINGS

Exemplary embodiment of the present disclosure will be described in detail based on the following figures, wherein:

FIG. 1 illustrates a whole configuration of a service system of an exemplary embodiment of the disclosure;

FIG. 2 is a block diagram illustrating a service system of the exemplary embodiment;

FIG. 3 illustrates an example of a data structure of a device management information stored on a device management information memory of the exemplary embodiment; and

FIG. 4 is a sequence chart illustrating a proxy registration process performed by a registration device according to the exemplary embodiment.

### DETAILED DESCRIPTION

Exemplary embodiment of the disclosure is described below with reference to the drawings.

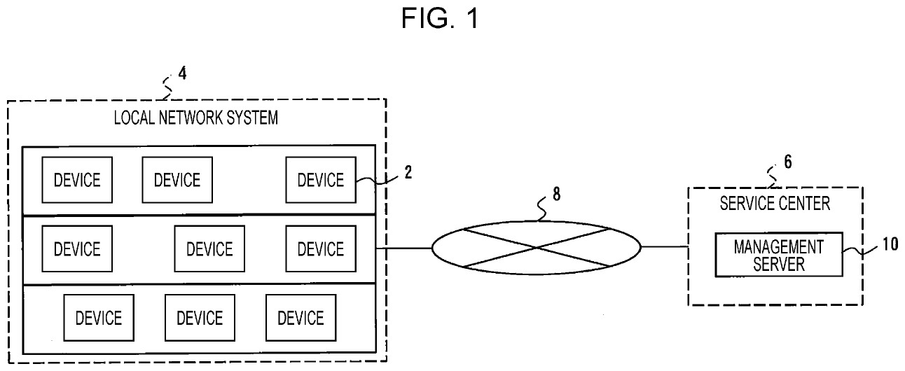

FIG. 1 illustrates a whole configuration of a service system of an exemplary embodiment of the disclosure. Referring to FIG. 1, a local network system 4 including multiple devices 2 is connected to a service center 6 centralizedly managing the devices 2 via the Internet 8. The service center 6 includes the management server 10 that manages information on the devices 2.

According to the exemplary embodiment, the device 2 included in the local network system 4 may be an IoT device. The IoT device refers to any things connected to the Internet 8. The IoT devices generally refer to things other than IT devices, such as personal computers and smart phones. In a broad sense, the IoT devices refer to all devices that are connected to the Internet 8 and capable of exchanging information. For example, the IoT devices include a variety of sensing devices (temperature sensor, humidity sensor, voltage sensor, current sensor, sound sensor, and the like), projector, display device, such as a liquid-crystal display, recording device, playback device, imaging device, such as a camera, clock, monitoring camera, unmanned aerial vehicle (drone), and game machine. The IoT devices further include a refrigerator, rice cooker, microwave oven, coffee maker, vacuum cleaner, washing machine, air-conditioner, and lighting equipment. According to the exemplary embodiment, the device 2 is a multi-function apparatus connected to the local network system 4 installed in facilities.

The multi-function apparatus is an information forming apparatus having image forming functions (scan function, print function, copy function, fax function, and the like). According to the exemplary embodiment, the multi-function apparatus is an information processing apparatus. The multi-function apparatus includes a computer, and thus includes a central processing unit (CPU), read-only memory (ROM), random-access memory (RAM), and storage, such as a hard disk drive (HDD) storing keys of the apparatus. The multi-function apparatus further includes an operation panel that works as a user interface receiving an instruction from a user and displaying information, a communication unit that has a communication function communicating via the Internet 8 and a short-range wireless communication function via Bluetooth (registered trademark) and Wi-Fi (registered trademark), and scanner and print engine used to operate as a multi-function apparatus.

The devices 2 of the exemplary embodiment are installed in a scattered fashion in an on-premise environment where the local network system 4 is constructed as illustrated in FIG. 1. For example, the devices 2 are installed on each floor of the facilities or in a room on the same floor. As described in greater detail below, simply installing the device 2 is not enough to use the service provided by the service center 6. The service provided by the service center 6 is readily available only after the public key of the device 2 is registered in the management server 10. According to the exemplary embodiment, the public key to be registered in the management server 10 to use the service is not a device public key unique to the device but an owner public key issued by the owner of the device. This will be described further below. The start of the usage of the service provided by the service center 6 with the public key of the device registered in the management server 10 is considered as equivalent to the registration in the service.

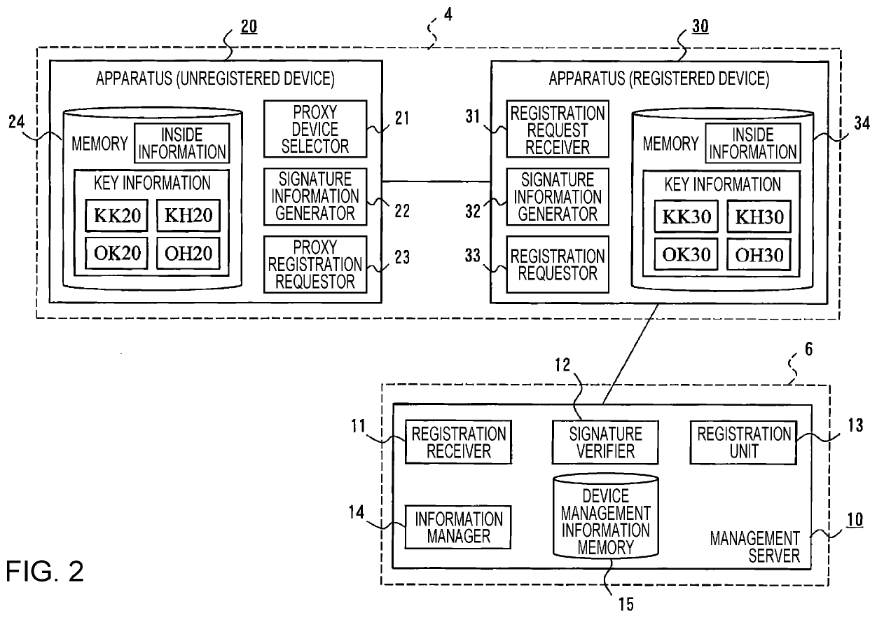

FIG. 2 is a block diagram illustrating the service system of the exemplary embodiment. As previously described, the device 2 is registered in the service when the public key of the device is registered in the management server 10. Referring to FIG. 1, a device 20 in FIG. 2 out of the devices 2 in FIG. 1 has no access to the service since the public key of the device is not registered in the management server 10. The device 20 is thus a second information processing apparatus that has no access to the service. On the other hand, a device 30 in FIG. 2 is authenticated by the service center 6 since the public key of the device is registered in the management server 10. The device 30 is thus a first information processing apparatus that has access to the service. In the following discussion, the device 20 that is not registered in the service is referred to as an “unregistered device 20,” and the device 30 that is registered in the service is referred to as a “registered device 30.” The device 20 and device 30, if not differentiated from each other in discussion, are representatively referred to as the “device 2.”

The unregistered device 20 includes a proxy device selector 21, signature information generator 22, proxy registration requestor 23, and memory 24. Elements not related to the discussion of the exemplary embodiment, such as elements related to the image forming functions, are not illustrated in FIG. 2. The same is true of the other devices 10 and 30.

The proxy device selector 21 searches for the registered device 30 that is eligible to be requested for proxy registration. The signature information generator 22 signs to certify that the device 20 is really own device and generates signature information. By transmitting information for the proxy registration, the proxy registration requestor 23 requests the device selected by the proxy device selector 21 to perform the proxy registration.

The information for the proxy registration of the exemplary embodiment is stored on the memory 24. FIG. 2 illustrates inside information and key information. The inside information is referenced when the proxy registration is selected. The data structure of the inside information will be described below together with a process performed to use the inside information.

According to the exemplary embodiment, the key information includes a key pair unique to the device 2 and a key pair depending on premises. The key pair unique to the device 2 is key information that is physically assigned to the device 2 before the device 2 is installed in the local network system 4 in a facility. The key pair unique to the device 2 includes a combination of a public key and private key unique to the device 2. The word “physically” has hardware-oriented meaning and even when the device 2 is moved to another installation location, the key information uniquely assigned to the device 2 remains unchanged. According to the embodiment, the key pair unique to the device 2 is referred to as “device unique keys” and in particularly, the public key is referred to as a “device public key” and the private key is referred to as a “device private key.” The device public key of the device 20 is denoted by “KK20,” and the device private key is denoted by “KH20.”

The key pair dependent on on-premise is key information that an administrator of the local network system 4 (referred to as an “owner” in the disclosure) generates for each device 2. The key pair includes a combination of a public key and private key that the owner assigns to each device 2. The key pair is referred to as owner authentication keys and, in particular, the public key of the device 2 is referred to as an “owner public key,” and the private key of the device 2 is referred to as an “owner private key.” The owner public key of the unregistered device 20 is denoted by “OK20,” and the owner private key of the unregistered device 20 is denoted by “OH20.” The owner authentication key is assigned by the owner, the change of ownership invalidates the owner authentication key, and a new owner authentication key is issued by a new owner. The owner public key of the exemplary embodiment corresponds to registration information registered in the management server 10. The registration of the owner public key in the management server 10 causes the unregistered device 20 to become the registered device 30 and the service is thus readily available.

The proxy device selector 21 through the proxy registration requestor 23 in the device 20 are implemented when a computer forming the device 20 and a program running on the CPU in the computer cooperatively work. The memory 24 is implemented by a recording medium mounted on the device 20. The memory 24 may be a RAM or an external recording medium connected via a network.

The device 30 includes a registration request receiver 31, signature information generator 32, registration requestor 33, and memory 34. The registration request receiver 31 receives a proxy registration request from the unregistered device 20. The signature information generator 32 signs to certify that the device 30 is really own device and generates signature information. The registration requestor 33 transmits information for registration to the unregistered device 20 and thus requests the management server 10 to register the unregistered device 20. When the registration requestor 33 receives results of a process performed by the management server 10 in response to the registration request, namely, a notification indicating whether the owner public key OK20 of the unregistered device 20 is normally registered, the registration requestor 33 notifies the unregistered device 20 serving as a proxy registration requestor of the contents of the notification.

The memory 34 stores information used for the proxy registration of the exemplary embodiment. FIG. 2 illustrates the inside information and key information. The inside information is referenced when a determination as to whether to meet a proxy registration request from the unregistered device 20 is made. The data structure of the inside information is described together with a process that uses the inside information.

The key information has been described in the discussion of the unregistered device 20. The key information registered on the memory 34 includes device unique keys unique to the device 30 and the owner authentication keys. The device public key of the device unique keys of the device 30 is denoted by “KK30,” and the device private key of the device unique keys is denoted by “KH30.” The owner public key of the owner authentication keys of the device 30 is denoted by “OK30”, and the owner private key of the owner authentication keys of the device 30 is denoted by “OH30.”

The registration request receiver 31 through registration requestor 33 in the device 30 are implemented when a computer forming the device 30 and a program running on the CPU in the computer work cooperatively. The memory 34 is implemented by a recording medium mounted on the device 30. The memory 34 may be a RAM or an external recording medium connected via a network.

The management server 10 stores the public keys of the device unique keys of the devices 2 installed in the local network system 4 as previously described and thus centralizedly manages the devices 2 that have access to the service provided by the service center 6. The management server 10 may include one or more general-purpose server computers. The management server 10 thus includes a CPU, ROM, RAM, recording medium, such as a hard disk drive (HDD) storing information on the device 2, and a communication unit used to perform network communication. The management server 10 may be formed on a cloud.

As illustrated in FIG. 2, the management server 10 includes a registration receiver 11, signature verifier 12, registration unit 13, information manager 14, and device management information memory 15. The registration receiver 11 receives from the device 2 a registration request for the service. In the process characteristic of the exemplary embodiment, a proxy registration request from the registered device 30 is accepted. Also, as with the case of the related art process, a registration request from the unregistered device 20 may also be accepted. Elements and operations in the related art process of receiving the registration request from the unregistered device 20 are not described herein. In response to the reception of the registration request from the registered device 30, the signature verifier 12 verifies a signature in accordance with signature information included in the registration request. If the signature is successfully verified, the registration unit 13 registers in the device management information memory 15 the owner public key OK20 of the unregistered device 20 transmitted during the registration request. If the owner public key OK20 is normally registered, the registration unit 13 notifies the registered device 30 serving as a registration requestor that the owner public key OK20 has normally registered, in other words, the service is readily available. The information manager 14 manages device management information stored on the device management information memory 15.

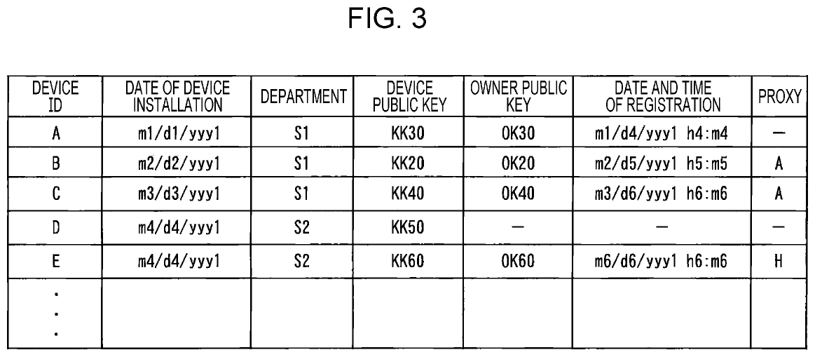

FIG. 3 illustrates an example of a data structure of the device management information stored on the device management information memory 15 of the exemplary embodiment. The device management information is related to the devices 2 installed in the local network system 4. The device management information includes a “device identification (ID)” identifying each device 2 and other pieces of information in an associated form. The other piece of information include “date of device installation” indicating a date on which the device 2 is installed in the local network system 4, “department” serving identification information identifying a department, such as a group that frequently uses the device 2, or a department that manages the device 2, “device public key” of device unique keys, “owner public key” serving as a public key of the owner authentication keys, “date and time of registration” serving as date and time information on the date on which the owner public keys are registered, and “proxy” indicating whether the owner public key is the proxy registration.

When the device 2 is installed in the facility and connected to the local network system 4 to be ready for use, the device management information on the device 2 is registered in the device management information memory 15 with the device ID, date of device installation, department, and device public key in default settings.

When the owner public key is set in the device management information, the corresponding date and time are set as date and time of registration of the owner key. The setting of the owner public key allows the device 2 to use the service provided by the service center 6. The device ID of the device 30 having performed proxy registration is set in the proxy of the device 2 proxy-registered by the device 30. Referring to the settings illustrated in FIG. 3, the devices 2 having the device IDs “B,” and “C” are proxy-registered by the device 2 having the device ID “A” (hereinafter referred to as a “device A”), and the device E is proxy-registered by the device H. The proxy of the device A is denoted by “-”, and thus has no device ID set therefor. This signifies that the device A performs a related art registration process to register the owner public key. Since the device D is installed in the local network system 4 with the owner public key not set for the device D, the registration of the owner public key is not completed. The default value “-” is thus set for the proxy column.

The device management information on each device 2 is deleted by removing the device 2 from the local network system 4. If a change occurs in item data set in the device management information in response to a change of ownership or transfer of the user from one department from another, the information manager 14 modifies or deletes the device management information in response to an instruction from an administrator or the like. Since the proxy registration is characteristic of the exemplary embodiment, the registration unit 13 is separately illustrated from the information manager 14 for convenience of explanation. Alternatively, the registration unit 13 may include the information manager 14.

The registration receiver 11 through information manager 14 in the management server 10 are implemented when a computer forming the management server 10 and a program running on the CPU in the computer work cooperatively. The device management information memory 15 is implemented by a recording medium mounted on the management server 10. The device management information memory 15 may be a RAM or an external recording medium connected via a network.

A program of the exemplary embodiment may be delivered via a communication medium or a computer readable recording medium in a recorded form, such as a compact-disk read-only memory (CD-ROM) or universal serial bus (USB) memory. The program delivered via the communication medium or computer readable recording medium is installed on a computer and a variety of processes may be performed when a CPU in the computer successively executes the processes.

An operation of the exemplary embodiment is described below.

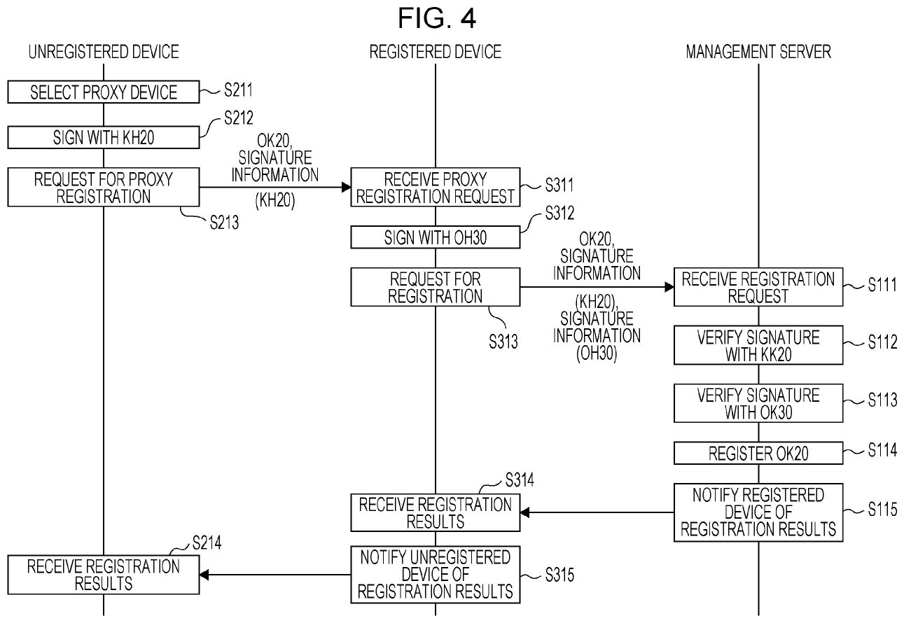

As previously described, the unregistered device 20 installed in the local network system 4 is to register the owner public key of the unregistered device 20 in the management server 10 and is thus able to use the service provided by the service center 6. According to the exemplary embodiment, the unregistered device 20 acting as a starting point requests the registered device 30 to perform the proxy registration. The proxy registration process performed by the device 30 of the exemplary embodiment is described with reference to a sequence chart in FIG. 4.

The proxy registration process of the exemplary embodiment starts when the unregistered device 20 requests the registered device 30 to perform the proxy registration. To this end, the unregistered device 20 searches for the registered device 30 from among the devices 2 present in the local network system 4. If multiple registered devices 30 are present, the unregistered device 20 selects a registered device 30 serving as a request destination (step S211).

The proxy device selector 21 thus searches for a device 2 that is capable of performing the proxy registration using an existing discovery function. If multiple registered devices 30 are found, the proxy device selector 21 may select a registered device 30 that is requested to perform the proxy registration from among the registered devices 30. The selection method will be described below. The following discussion herein is based on the assumption that a single registered device 30 has been found.

When the registered device 30 serving as the request destination of the proxy registration is identified, the signature information generator 22 signs using the device private key KH20 (step S212). Specifically, the signature information generator 22 generates the signature information by encoding any character string (hereinafter referred to as a second plaintext) with the device private key KH20. The signature information corresponds to second signature information and includes the second plaintext and a signature value that the unregistered device 20 generates using the device private key KH20. The proxy registration requestor 23 requests the registered device 30 to perform the proxy registration by transmitting a registration representation instruction including the signature information and the owner public key OK20 intended for a registration target to the management server 10 (step S213). The signature information includes data (the second plaintext) that serves as a target to be signed and the signature value. The technique related to the signature may be one of the related art techniques.

When the unregistered device 20 requests the registered device 30 to perform the proxy registration, the registration request receiver 31 receives the request (step S311). The registration request receiver 31 may determine whether to perform the proxy registration in response to the request. The determination is described below. The following discussion herein is based on the assumption that the request has been met.

When the request has been met, the signature information generator 32 signs using the owner private key OH30 (step S312). Specifically, the signature information generator 32 generates the signature information by encoding any character string (first plaintext) with the owner private key OH30. The signature information that the registered device 30 generates using the owner private key OH30 includes the first plaintext and signature value, and corresponds to first signature information. The owner public key OK30 paired with the owner private key OH30 serves as certification information certifying the registration in the management server 10. The registration requestor 33 thus requests the management server 10 to register the owner public key of the unregistered device 20, by transmitting a proxy registration instruction (step S313). The proxy registration instruction includes the second signature information and the owner public key OK20 received from the unregistered device and the first signature information generated in step S312.

When the registration receiver 11 in the management server 10 receives the proxy request from the registered device 30 by receiving the proxy registration instruction from the registered device 30 (step S111), the signature verifier 12 extracts the device public key KK20 of the unregistered device 20 from the device management information and verifies the signature attributed to the device private key KH20 with the device public key KK20 (step S112). Specifically, the signature verifier 12 first decodes the signature value included in the second signature information using the device public key KK20, and checks the signature value with the second plaintext for a match. In this way, the signature verifier 12 verifies the second signature information. The technique used for verification may be one of the related art techniques.

When the second signature information on the unregistered device 20 has been successfully verified, the signature verifier 12 extracts from the device management information the owner public key OK30 of the registered device 30 serving as a requestor, and verifies the signature attributed to the owner private key OH30 with the owner public key OK30 (step S113). Specifically, the signature verifier 12 decodes the signature value included in authentication information using the owner public key OK30, and checks the signature value against the first plaintext a match. In this way, the signature verifier 12 verifies the first signature information. In other words, the signature verifier 12 verifies in accordance with the authentication information that the registered device 30 has been registered in the service. The verification technique may be one of the related art techniques. According to the exemplary embodiment, a two-factor authentication is performed using the owner authentication key of the registered device 30 and the device unique key of the unregistered device 20. The two-factor authentication may be performed in a reverse order.

As previously described, the two-factor authentication is performed in the exemplary embodiment. Since the proxy registration of the unregistered device 20 is performed using credibility of the registered device 30, authentication is to be performed using the owner authentication key of the registered device 30. On the other hand, the device unique key remains valid even when the device 2 is used even after being transferred to another department or the outside. The other department may thus have access to the device unique key. The authentication based on the device unique key is not necessarily secure and is thus not necessarily to be performed. According to the exemplary embodiment, however, the two-factor authentication is performed for security reason.

If the management server 10 has successfully completed the two-factor authentication, the registration unit 13 registers, in the device management information on the unregistered device 20, the owner public key OK20 of the unregistered device 20 received in step S111 (step S114). When the owner public key is registered in the management server 10, the unregistered device 20 having requested for the proxy registration is a registered device 30 from now on.

When the owner public key OK20 of the unregistered device 20 is registered in the device management information in response to the proxy registration request from the unregistered device 20, the registration unit 13 notifies the registered device 30 as the requestor that the registration has been successfully completed (registration results) (step S115). The unregistered device 20 has successfully been registered herein. If the unregistered device 20 has not successfully been registered, the signature verifier 12 may notifies the registered device 30 of an unsuccessful registration as the registration results and reason for the unsuccessful registration.

When the registration requestor 33 in the registered device 30 receives the results of the proxy registration (the registration results) notified by the management server 10 (step S314), the registration requestor 33 notifies the unregistered device 20 as a proxy registration requestor of the registration results (step S315).

The proxy registration requestor 23 in the unregistered device 20 receives the registration results from the registered device 30 (step S214), and determines whether the proxy registration request has been met or not. If the proxy registration is not successful, the proxy registration requestor 23 may request another registered device 30 or register the unregistered device 20 itself in the management server 10 as in the related art technique.

According to the exemplary embodiment, the unregistered device 20 acting as a starting point may start the proxy registration process and register the owner public key of the unregistered device 20 in the management server 10.

As described below, the unregistered device 20 performs a selection method in step S211 to select a registered device 30.

If there are multiple registered devices 30 that have the proxy registration function, namely, have the functional blocks in FIG. 2, the unregistered device 20 selects a registered device 30 satisfying a predetermined condition described below. For example, if the service provided by the service center 6 supports a pay-per-use method or a license method, the unregistered device 20 selects a registered device 30 having the same terms of use, for example, belonging to the same group. Information on the group is included in the inside information on the memory 24. Also, the unregistered device 20 may select a registered device 30 if the registered device 30 has with the unregistered device 20 an experience of cooperation operation in an execution of a process. Log information on the cooperation operation is included in the inside information on the memory 24.

As described below, the registered device 30 performs a determination method in step S311 to determine whether to meet the registration representation instruction from the unregistered device 20.

For example, the predetermined condition is set in advance and if the predetermined conditions is satisfied, the registration representation instruction may be met. For example, the predetermined condition may be that predetermined information is included in the registration representation instruction from the unregistered device 20. If secret information shared with the registered device 30 is included as the predetermined information in the registration representation instruction, the registered device 30 determines that the secret information shared with the registered device 30 is thus acquired from the unregistered device 20 and thus meets the proxy registration request from the unregistered device 20.

The predetermined condition may be that the proxy registration request is made between the devices 2 with information (hereinafter referred to as “group information”) indicative of a belonging group being included in the registration representation instruction or the predetermined condition may be that the same group information as the group information on the registered device 30 is included in the registration representation instruction. In such a case, the registered device 30 meets the proxy registration request from the unregistered device 20, based on the assumption that the unregistered device 20 belongs to the same group as the registered device 30.

The predetermined condition is further described. For example, when identification information (such as the device ID) of the unregistered device 20 is acquired, log information, such as a job log, is referenced. The registered device 30 then determines whether there is a past recording indicating data exchange with the device ID. If a past record indicating a cooperative operation, such as data exchange, is found, the registered device 30 determines that the unregistered device 20 is credible and meets the proxy registration request from the unregistered device 20.

The secret information used to determine whether to meet the proxy registration request, group information, and log information are included the inside information on the memory 34. In the discussion herein, the registered device 30 and the unregistered device 20 belong to the same group. The group information on the group serving as a reception target of the proxy registration request may be set and registered in the inside information.

According to the exemplary embodiment, the proxy registration is set to be available to the owner for owner convenience as described above, apart from the standard registration method in which the owner manually operates the device 2 to register the owner public key. Specifically, in the proxy registration method of the exemplary embodiment, the unregistered device 20 may be easily registered using the credibility of the registered device 30. It may be contemplated that the device 2 proxy-registered by another device 2 is differentiated from the device 2 that is registered in the service according to the standard registration method. If a predetermined deletion condition is satisfied about a registration status to the service, the owner public key of the device 2 registered in response to the proxy registration instruction from the other device 2 may be deleted.

According to the exemplary embodiment, the registered device 30 serving as the proxy registration requestor is notified in step S115 in FIG. 4 that the proxy registration has been completed. For example, the predetermined deletion condition may be that a registration cancel instruction is provided by the administrator of the registered device 30. When the management server 10 receives the registration cancel instruction from the administrator, the registered device 30 deletes from the device management information the owner public key of the proxy-registered device 2. In this way, the device 2 with the owner public key deleted is not able to use the service any longer.

If multiple devices 2 are proxy-registered, the administrator of the registered device 30 may provide the registration cancel instruction by specifying the device 2 that is set to be unable to use the service.

The proxy registration method of the exemplary embodiment simply registers the unregistered device 20 in the service in accordance with the credibility of the registered device 30. The registered device 30 and the unregistered device 20 are constructed as a superior-subordinate relationship with the registered device 30 serving as a superior entity and the unregistered device 20 serving as a subordinate entity. In such a superior-subordinate relationship, the service may become unavailable in response to a request from the registered device 30 or the management server 10, in other words, the owner public key of the registered device 30 may be deleted from the device management information. In such a case, it may be appropriate that the unregistered device 20 proxy-registered by the registered device 30 is also set to be unable to use the service.

The predetermined deletion condition may be that the owner public key of the registered device 30 has been deleted from the device management information. If the owner public key of the registered device 30 is deleted from the device management information, the owner public key of the device 2 proxy-registered by the registered device 30 is also deleted from the device management information. In this way, the device 2 with the owner public key deleted is unable to use the service any longer.

The relationship between the device 2 having proxy-registered and the proxy-registered device 2 may be identified by referencing the device ID set in the “proxy” in the device management information. Not only the owner public key but also the date and time of registration of the owner public key and the proxy are deleted together. The device management information itself is not deleted unless the device 2 is removed from the local network system 4. The device 2 set to be unable to use the service may be activated to be able to use the service again. In such a case, the proxy registration request is made to another registered device 30 or the device 2 registers itself in the service through the standard registration method.

The device 2 registered in the service through the standard registration method and the proxy-registered device 2 may be differently handled. The difference in the registration method may be determined by referring to whether the device ID is set in the proxy of the device management information.

An upper limit may be imposed on the number of devices registered in the service, and the actual number of registered devices may exceed the upper limit. In such a case, the owner public key of the device 2 registered through the proxy registration is deleted with a higher priority. If multiple devices 2 are proxy-registered, the deletion priority may be in the order of from older to younger date of device installation or in the order of from younger to older date of device installation. Alternatively, if the devices 2 are prioritized with a priority, such as a degree of importance, the deletion order may be determined by referring to the priority of the proxy-registered devices 2.

The service center 6 may provide multiple types of service. The function of service available on the proxy-registered device 2 may be limited such that the proxy-registered device 2 is handled in a manner different from the device 2 that is registered in the service through the standard registration method.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

A program causing a computer to execute a process, the computer included in an information processing apparatus that is registered in a service by registering, in a management server, registration information unique to the information processing apparatus, the process comprising:
in response to a registration representation instruction from a second information processing apparatus having no access to the service, transmitting, to the management server, a proxy registration instruction including certification information certifying that registration information unique to the second information processing apparatus and the registration information unique to the information processing apparatus have been registered in the management server, the registration information that is included in the registration representation instruction and is to be registered in the management server.

1. An information processing apparatus that is registered in a service by registering, in a management server, registration information unique to the information processing apparatus, the information processing apparatus comprising:
a processor configured to:
in response to a registration representation instruction from a second information processing apparatus having no access to the service, transmit, to the management server, a proxy registration instruction including certification information certifying that registration information unique to the second information processing apparatus and registration information unique to the information processing apparatus have been registered in the management server, the registration information unique to the second information processing apparatus being included in the registration representation instruction to be registered in the management server.

2. The information processing apparatus according to claim 1, wherein the processor is configured to meet the registration representation instruction from the second information processing apparatus if the second information processing apparatus satisfies a predetermined proxy condition.

3. The information processing apparatus according to claim 2, wherein the predetermined proxy condition is that confidential information shared by the information processing apparatus and the second information processing apparatus has been acquired from the second information processing apparatus.

4. The information processing apparatus according to claim 2, wherein the predetermined proxy condition is that information indicating that the information processing apparatus and the second information processing apparatus belong to one group has been acquired from the second information processing apparatus.

5. The information processing apparatus according to claim 2, wherein the predetermined proxy condition is that log information related to an exchange of data between the information processing apparatus and the second information processing apparatus is present.

6. A management server managing registration information unique to an information processing apparatus registered in a service, the management server comprising:
a processor configured to:
in response to a registration representation instruction from a second information processing apparatus having no access to the service, receive, from the information processing apparatus, a proxy registration instruction including certification information certifying that registration information unique to the second information processing apparatus and registration information unique to the information processing apparatus have been registered in the management server, the registration information unique to the second information processing apparatus being included in the registration representation instruction to be registered in the management server;
verify in accordance with the certification information included in the proxy registration instruction that the information processing apparatus has been registered in the service; and
in response to a successful verification, register the registration information that is unique to the second information processing apparatus and included in the proxy registration instruction.

7. A service system comprising:
the management server managing registration information unique to an information processing apparatus registered in a service, the management server comprising:
a processor configured to:
in response to a registration representation instruction from a second information processing apparatus having no access to the service, receive, from the information processing apparatus, a proxy registration instruction including certification information certifying that registration information unique to the second information processing apparatus and registration information unique to the information processing apparatus have been registered in the management server, the registration information unique to the second information processing apparatus being included in the registration representation instruction to be registered in the management server;
verify in accordance with the certification information included in the proxy registration instruction that the information processing apparatus has been registered in the service; and
in response to a successful verification, register the registration information that is unique to the second information processing apparatus and included in the proxy registration instruction;
the information processing apparatus according to claim 1, serving as a first information processing apparatus among information processing apparatuses included in a local network system; and
an information processing apparatus, serving as a second information processing apparatus having no access to the service among the information processing apparatuses included in the local network system.

8. The service system according to claim 7, wherein a first owner public key that is a public key generated for the first information processing apparatus in the local network system and a second owner public key that is a public key generated for the second information processing apparatus in the local network system are used as the registration information of the first information processing apparatus and the second information processing apparatus, respectively.

9. The service system according to claim 8, wherein a two-factor authentication is performed by using owner authentication keys and device authentication keys, the owner authentication keys being a combination of the first owner public key, the second owner public key, a first owner private key, and a second owner private key, the first owner private key and the second owner private key being private keys respectively generated for the first information processing apparatus and the second information processing apparatus in the local network system, the device authentication keys being a combination of a first device public key, a second device public key, a first device private key, and a second device private key, the first device public key and the second device public key being public keys respectively unique to the first information processing apparatus and the second information processing apparatus, the first device private key and the second device private key being private keys respectively unique to the first information processing apparatus and the second information processing apparatus.

10. The service system according to claim 9, wherein the management server stores the first device public key, the second device public key, and the first owner public key;
wherein a second processor included in the second information processing apparatus is configured to:
generate second signature information by signing with a private key corresponding to the second device public key; and
transmit to the first information processing apparatus the registration representation instruction including the second owner public key and the second signature information;
wherein a first processor included in the first information processing apparatus is configured to:
in response to the registration representation instruction from the second information processing apparatus, generate first signature information as the certification information by signing with a private key corresponding to the first owner public key; and
transmit the proxy registration instruction to the management server, the proxy registration instruction including the second owner public key and the second signature information that are included in the registration representation instruction, and the first signature information;
wherein a third processor included in the management server is configured to:
in response to the proxy registration instruction from the first information processing apparatus, verify the second signature information included in the proxy registration instruction, by using the second device public key;
in response to a successful verification of the second signature information, verify the first signature information included in the proxy registration instruction, by using the first owner public key; and
in response to a successful verification of the first signature information, register the second owner public key included in the proxy registration instruction.

11. The service system according to claim 10, wherein the third processor is configured to, if a predetermined deletion condition is satisfied, delete the registration information unique to the second information processing apparatus and registered in response to the proxy registration instruction from the first information processing apparatus.

12. The service system according to claim 11, wherein if the third processor notifies an administrator that the registration information unique to the second information processing apparatus has been registered, the predetermined deletion condition is that a registration cancel instruction has been provided by the notified administrator.

13. The service system according to claim 11, wherein if the management server manages the first information processing apparatus that has proxy-registered the registration information unique to the second information processing apparatus and the second information processing apparatus whose registration information has been proxy-registered in association with each other, the predetermined deletion condition is that the registration information unique to the first information processing apparatus having transmitted the proxy registration instruction to the management server has been deleted.

14. The service system according to claim 10, wherein the third processor is configured to:
manage the first information processing apparatus such that a determination as to whether the registration information unique to the first information processing apparatus has been registered using proxy registration is made; and
differentiate a manner of handling the service to the first information processing apparatus, depending on whether the proxy registration is used or not.

15. The service system according to claim 14, wherein the third processor is configured to: if a number of registrations of the registration information on the management server exceeds an upper limit, delete the registration information on the management server with a higher priority placed on the first information processing apparatus whose public key is registered using the proxy registration.

16. The service system according to claim 14, wherein the third processor is configured to restrict a function of the service that is available to the first information processing apparatus whose registration information is registered using the proxy registration.

17. A non-transitory computer readable medium storing a program causing a computer to execute a process, the computer included in in a management server managing registration information unique to an information processing apparatus registered in a service, the process comprising:
in response to a registration representation instruction from a second information processing apparatus having no access to the service, receiving, from the information processing apparatus, a proxy registration instruction including certification information certifying that registration information unique to the second information processing apparatus and the registration information unique to the information processing apparatus have been registered in the management server, the registration information unique to the second information processing apparatus being included in the registration representation instruction to be registered in the management server;
verifying in accordance with the certification information included in the proxy registration instruction that the information processing apparatus has been registered in the service; and
in response to a successful verification, registering the registration information that is unique to the second information processing apparatus and included in the proxy registration instruction.
